(19) United States
(12) Patent Application Publication
(10) Pub. No.: US 2007/0247375 A1
(43) Pub. Date: Oct. 25, 2007

(54) Multi-Angle Seat For Antenna

(76) Inventor: Tommy Huang, Taipei (TW)

Correspondence Address: Barley Snyder, LLC, Suite 275, 1000 Westlakes Drive, Berwyn, PA, 19312, US

(21) Appl. No.: 11/737,555

(22) Filed: Apr. 19, 2007

(30) Foreign Application Priority Data
Apr. 19, 2006 (TW) 95206656

(51) Int. Cl. H01Q 1/24

(52) U.S. Cl. 343/702; 343/906

(57) ABSTRACT

A wide-angle seat for an antenna includes a seat having a shaft and a tab located thereon, a first socket having a first slot on one end thereof and a protuberance on the other end thereof where the two sides of the first slot are not connected with each other, and a second socket having a second slot on one end thereof. The tab of the seat is inserted in the first slot of the first socket, and thereby a wide-angle rotation and shift thereof is achieved. Moreover, the protuberance of the first socket is inserted in the second slot of the second socket, and thereby the seat is driven by the first socket to rotate in a partial range of angle. Furthermore, since the two sides of the first slot are not connected with each other, the seat is able to be positioned after the wide-angle rotation, and the disruption of signal transmission lines resulting from an over-rotation of the seat is also prevented.

### CROSS-REFERENCE TO RELATED APPLICATIONS

This application claims the benefit of the filing date under 35 U.S.C. § 119(a)-(d) of Taiwan, R.O.C. Patent Application No. 95206656, filed Apr. 19, 2006.

### FIELD OF THE INVENTION

The present invention relates to a multi-angle seat for an antenna, and more particularly, to a multi-angle seat which enables a wide-angle rotation and prevents the disruption of signal transmission lines.

### BACKGROUND OF THE INVENTION

In Taiwan Patent Pub. No. 534,465, a combination structure of the antenna rotating-positioning joint disclosed therein principally includes a protruding pillar for the right and the left slots on the seat for an external joint thereof, which are inserted in the through-holes on the connecting components of the seat for an internal joint thereof, and a positioning protruding piece inserted into a correspondent positioning slot. The protruding pillar serves as a rotation axis, and the seat for the external joint is accordingly rotated with respect to the seat for the internal joint. The seat for the external joint is positioned at a specific angle with respect to that for the internal joint by inserting the positioning protruding piece into one of the positioning slots.

The mentioned combination structure of the antenna rotating-positioning joint enables the seat for the external joint to be positioned at a specific angle with respect to that for internal joint. Nevertheless, while the antenna adapted to such a joint is rotated with the rotation thereof, the external joint can only rotate in an angle of 180°. In this case, when such a joint is applied in the electronic application, the antenna may fail in a wide-angle shifting operation since the rotating angle thereof is limited.

For overcoming the mentioned drawbacks existing in the conventional schemes, it is desired to develop a multi-angle seat for an antenna that can also enable a wide-angle rotation and prevent the disruption of signal transmission lines.

### SUMMARY OF THE INVENTION

The invention provides a multi-angle seat for an antenna including a seat, having a shaft and a tab configured thereon; a first socket, having a first slot on one end thereof and a protuberance on the other end thereof where the two sides of the first slot are not connected with each other; and a second socket, having a second slot on one end thereof.

The tab of the seat is inserted in the first slot of the first socket and thereby a wide-angle rotation and shift thereof is achieved. Moreover, the protuberance of the first socket is inserted in the second slot of the second socket, and thereby the seat is driven by the first socket to rotate in a partial range of angle. Furthermore, since the two sides of the first slot are not connected with each other, the seat is able to be positioned after the wide-angle rotation, and the disruption of signal transmission lines resulting from an over-rotation of the seat is also thereby prevented.

### BRIEF DESCRIPTION OF THE DRAWINGS

The foregoing and other features and advantages of the invention will be more clearly understood through the following descriptions with reference to the drawings of which:

FIG. 1 is an exploded perspective view of the structure according to an embodiment of the invention;

FIG. 2 is a perspective view of an embodiment of the invention;

FIG. 3 is a diagram showing the rotation of the seat with respect to the first socket according to an embodiment of the invention;

FIG. 4 is a diagram showing the rotation of the first socket with respect to the second socket according to an embodiment of the invention; and

FIG. 5 is a diagram showing the rotation of the tab with respect to the protuberance according to an embodiment of the invention.

### DETAILED DESCRIPTION OF THE PREFERRED EMBODIMENT

The invention will now be described more specifically with reference to the following embodiments. It is to be noted that the following descriptions of embodiments of this invention are presented herein for the purpose of illustration and description only. They are not intended to be exhaustive or to be limited to the precise form disclosed.

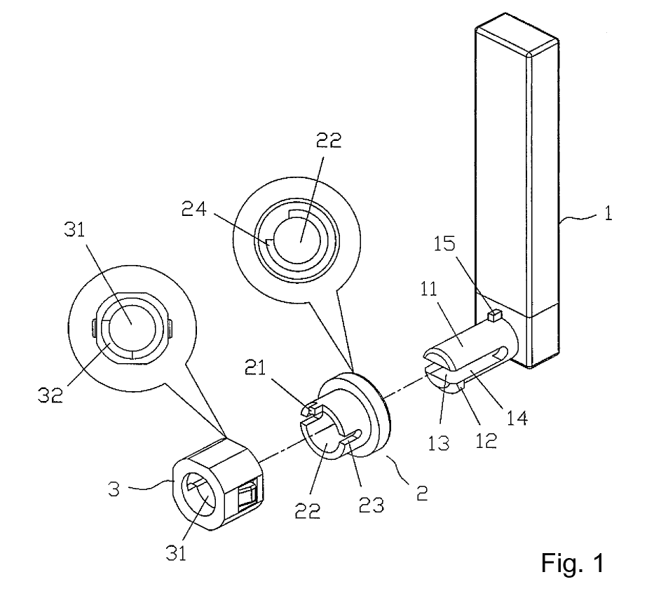

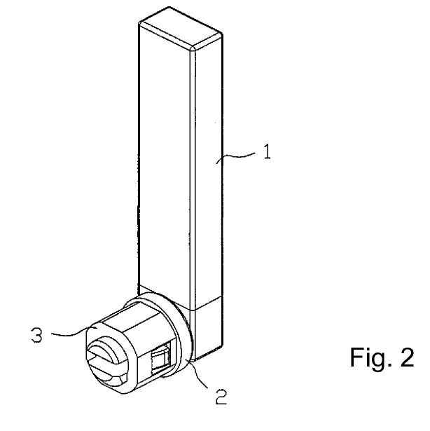

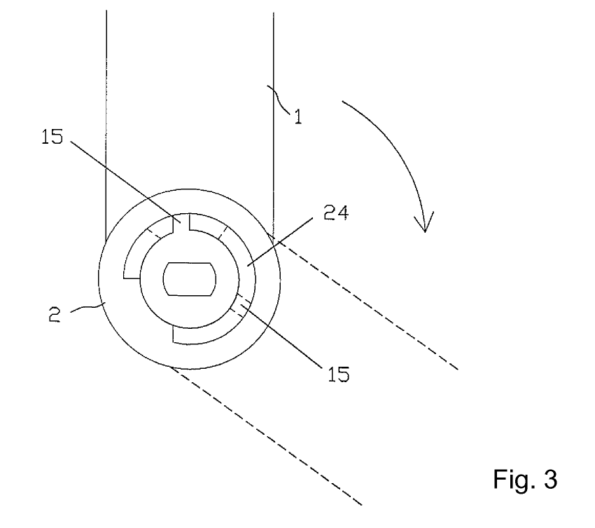

With reference to FIGS. 1 and 2, the multi-angle seat for antenna according to the embodiment shown mainly includes a seat 1 having a shaft 11 and a tab 15 configured thereon, a first socket 2 and a second socket 3. Referring to FIG. 3 as well, the tab 15 is inserted in the first slot 24 formed on the first socket 2, between the shaft 11 and the seat 1. The shaft 11 has a hollow portion 13 running therethrough and at least two grooves 14 formed thereon, so as to give the shaft 11 some resiliency. Moreover, on one end of the shaft 11, a fastener 12 is located. The shaft 11 passes through the hollow portion 22 of the first socket 2 and the hollow portion 31 of the second socket 3, and is fastened on the other end of the second socket 3 by a fastener 12.

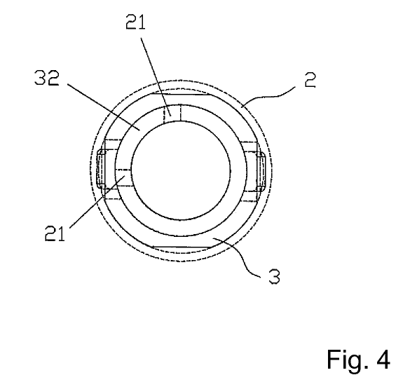

The two sides of the first slot 24 formed on one end of the first socket 2 are not connected to each other, and on the side of the other end of the first socket 2, a protuberance 21 is located. The hollow portion 22 runs through the first socket 2, and thereon at least two grooves 23 are formed, so that the first socket 2 is also somewhat resilient. The first socket 2 passes through the hollow portion 31 of the second socket 2, and the protuberance 21 is inserted in the second slot 32 of the second socket 3, as shown in FIG. 4.

The hollow portion 31 running through the second socket 3 having the second slot 32 receives a signal transmission line (not shown) therein, so that the signal transmission line is coupled with the antenna located in the seat 1 through the hollow portion 13 of the shaft 11.

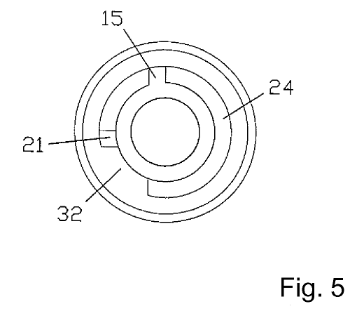

Referring to FIG. 5 in combination with FIG. 1, the tab 15 of the seat 1 is inserted in the first slot 24 of the first socket 2, whereby a wide-angle rotation and shift of the seat 1 is achieved. Moreover, the protuberance 21 of the first socket 2 is inserted in the second slot 32 of the second socket 3, and thereby the seat 1 is driven by the first socket 2 to rotate in an angle. Furthermore, since the two sides of the first slot 24 of the first socket 2 are not connected with each other, the seat 1 is able to be positioned after the wide-angle rotation, and the disruption of signal transmission lines resulting from an over-rotation of the seat 1 is also thereby prevented.

The conventional seat for an antenna is disadvantageous in a merely 180°-rotation, so that the rotating angle of the antenna adapted thereto is limited and hence the antenna cannot be positioned or rotated in a wide-angle.

In comparison with the conventional schemes, the present invention has an advantage of a 360°-rotation of antenna, the wide-angle positioning of an antenna and the prevention of the disruption of signal transmission lines caused by an over-rotation.

While the invention has been described in terms of what is presently considered to be the most practical and preferred embodiment, it is to be understood that the invention need not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A multi-angle seat for antenna, comprising:
a seat having a shaft and a tab;
a first socket for the shaft, having a first slot on one end of the first socket corresponding to the shaft and a protuberance on the other end thereof, wherein the tab is inserted in the first slot; and
a second socket for the shaft, having a second slot on one end thereof in which the protuberance is inserted.

2. The multi-angle seat for antenna of claim 1, wherein the shaft has at least two grooves formed thereon.

3. The multi-angle seat for antenna of claim 1, wherein the shaft comprises a fastener located thereon.

4. The multi-angle seat for antenna of claim 1, wherein the first socket has at least two grooves formed thereon.

5. The multi-angle seat for antenna of claim 1, wherein the two ends of the first slot are not connected to each other.
